(19) United States
(12) Patent Application Publication
(10) Pub. No.: US 2020/0060259 A1
(43) Pub. Date: Feb. 27, 2020

(54) SMALL RUMINANT SEMEN FREEZING DILUENT

(71) Applicant: Guobo QUAN, (US)

(72) Inventors: Guobo QUAN, Kunming City (CN); Qionghua HONG, Kunming City (CN); Qingyong SHAO, Kunming City (CN); Guoquan WU, Kunming City (CN); Chunrong LV, Kunming City (CN)

(73) Assignee: Guobo QUAN, Kunming City (CN)

(21) Appl. No.: 16/078,009

(22) PCT Filed: Nov. 25, 2016
(86) PCT No.: PCT/CN2016/000656

§ 371 Date: Aug. 7, 2019

(30) Foreign Application Priority Data
Feb. 16, 2016 (CN) 201610086372.X

(51) Int. Cl. A01N 1/02

(52) U.S. Cl. CPC A01N 1/0221; A01N 1/0226

(57) ABSTRACT

The present invention relates to a small ruminant semen freezing diluent, comprising, for each 100 ml, the following components: 2.71 g of trihydroxymethyl aminomethane, 1.4 g of citric acid, 1.0 g of monosaccharide, 5-20 ml of fresh egg yolk, 0-10 ml of osmotic protective agent, 0.1 million IU of penicillin, 0.1 million IU of streptomycin, 50-600 mMol of inositol compounds, 0.1-50 μMol of resveratrol, and the rest of ultra-pure water. In this invention, resveratrol is firstly and successfully applied to the small ruminant semen freezing field, improving the quality of the frozen semen, thereby being low in costs, stable in chemical property, and simple and easy to use.

### TECHNICAL FIELD

The present invention relates to the field of animal reproductive physiology and reproductive technology and in particular, to small ruminant semen freezing diluent.

### BACKGROUND ART

Though the research on freezing preservation of livestock semen has been carried out for over 50 years, thawed semen has the vitality only about 30%-50%, and both non-return rate and calving rate after artificial insemination is significantly lower than that of fresh and cryopreserved semen. In the process of freezing animal semen, the damage that spermatids suffered are primarily physical, caused by ice crystals formed inside and outside the cell membrane, thus, to reduce the formation of ice crystals has always been a hot research topic in the field of low temperature biology there have been a large number of studies showing that sperm damage from freezing can be reduced by changing components of semen diluent, primarily by adding certain permeable organic solvent and saccharides, egg yolk, ice crystal inhibitors, etc. into semen diluent, in which permeable organic solvent and saccharides, egg yolk can all improve the survive rate of frozen sperm cell, but cannot inhibit the formation of ice crystals. Though the ice crystal inhibitors are capable of inhibiting formation of ice crystals, there are still many problems in actual application.

Firstly, the existing ice crystal inhibitors are best with antifreeze proteins, but the antifreeze protein technology has been kept in the hands of developed countries. The antifreeze proteins currently available are imported from abroad and are expensive, and after using the antifreeze proteins, although the amount of formed ice crystals is reduced, the formed ice crystals are needle-like and the mechanical damage to the cells is sometimes rather greater.

Secondly, the applicant in the patent, application no.: CN201210491289.2 described chemically synthesized ice crystal inhibitors, a kind of inositol compounds, which are used to replace the antifreeze proteins used for mammalian semen cryopreservation. Due to the hexagonal structure unique to inositol compounds, the formed ice crystals are also hexagonal, which thereby reduces the damage to sperm structure and function caused by formation of ice crystals in the process of freezing. Although ice crystal inhibitors of inositol compounds can alleviate the adverse effects of ice crystals on structures such as sperm plasma membranes and mitochondria in the process of freezing and thawing, the damage to sperm cell structure by freezing is still severe. Especially due to the particularity of the cryopreservation procedure, the low temperature equilibration of frozen semen at 0-5° C. is critical for the survival of frozen sperm. Usually this process takes 2-4 hours, but the metabolic activity of the sperm does not stop completely at 0-5° C., and its metabolites may cause severe oxidative damage and apoptosis to the sperm, eventually causing damage to the cell structure. The common practice in the art is to add certain antioxidants (vitamin C, vitamin E, superoxide dismutase, catalase, glutathione peroxidase, etc.) into the semen freezing dilution to remove the reactive oxygen species formed in the freezing and thawing process.

However, during low temperature equilibration at 0-5° C., the mechanism of sperm cell metabolism remains unclear, the mechanism of cell damage is unclear too, and damage done to spermatozoa of different species are also different from each other, furthermore, the sperm cells are tiny and fragile, the freezing results can be comparably different if the compatibility and the dosage of various chemical reagents varies slightly.

Therefore, just introducing antioxidants cannot address the damage to sperm cells at low temperature equilibrium of 0-5° C., and one compatible method can't be used to all kinds of animals either.

In the livestock breeding industry, excellent male animals are picked out after several rounds of selection. In order to maximize livestock quantity with the fine male animals, common practice in the industry is to provide as much semen of excellent male animals as possible to inseminate female animals in estrus. The most scientific and economical way is to freeze the collected semen after dilution, and when necessary defreeze it before providing to female animals by artificial insemination. In this way, the genes of excellent male animals can be expanded rapidly, but this practice is limited to wide and systematic implementation in cattle rearing industry. Whereas when it comes to small ruminants such as goats and sheep, due to the characteristics of the species, ejaculation amount of the sheep is relatively small, and the sperm is sensitive to freezing damage.

Consequently, both use and promotion of semen freezing technology in the sheep raising industry are far less than those in the cattle industry.

Live sheep mating method for insemination is still used in many places of practice, which greatly limits the multiplication of excellent rams, and renders it hard to take use of genes from excellent rams carefully selected for many years and progress in flock improvement slow.

### SUMMARY OF THE PRESENT INVENTION

In the present invention, based on using previously disclosed chemically synthesized ice crystal inhibitors—inositol compounds to freezing preserve the livestock semen, resveratrol is further introduced to observe the effects of compatibility of the two concentrations on the freezing preserve of the semen of small ruminants, which thereby avoids the defects of using ice crystal inhibitors alone. Corresponding researches have not been published yet.

The small ruminant semen freezing diluent in the present invention, each 100 ml of which includes the following components:
2.71 g of trishydroxymethyl aminomethane,
1.4 g of citric acid,
1.0 g of monosaccharide,
5-20 ml of fresh egg yolk,
0-10 ml of osmotic protective agent,
0.1 million IU of penicillin,
0.1 million IU of streptomycin,
50-600 mMol of inositol compounds,
0.1-50 μMol of resveratrol,
and the rest of ultra-pure water.

Further, the inositol compounds comprise any of i) 3-cyclohexanediol; ii) 4-cyclohexanediol and iii), 5-cyclohexanetriol.

Further, the monosaccharide comprises glucose or fructose.

Further, the osmotic protective agent may comprise glycerin or ethylene glycol.

Further, the fresh egg yolk has been inactivated at 56° C. for 30 minutes.

Preparation method for the small ruminant semen freezing diluent includes the steps below: weigh respectively 2.71 g of trishydroxymethyl aminomethane, 1.4 g of citric acid, 1.0 g of monosaccharide, 5-20% of osmotic protective agent, 0.1 million IU of penicillin, 0.1 million IU of streptomycin, 50-600 mMol of inositol compounds, 0.1-50 μMol of resveratrol, dissolve them in ultra-pure water; stir evenly and adjust the PH of the solution to 6.8-7.2 with trishydroxymethyl aminomethane; and add 5-20 ml of fresh egg yolk inactivated at 56° C. for 30 min into the solution before use; mix well and dilute to 100 ml; centrifuge the mixture at 15000 rpm for 1 hour at 4° C.; and take the supernatant to filter with a 0.45 μm disposable filter for use.

The small ruminant semen freezing diluent in the present invention can be used in one-step freezing preserve of small ruminant semen including sheep and goats, and steps thereof are to mix sheep semen and the semen freezing diluent of the present invention evenly in a ratio of 1:10; sub-package the mixture in 0.25 ml plastic thin tubes; slowly lower the temperature to 5° C.; move it rapidly into the gaseous phase of liquid nitrogen for fumigation for 5 min; finally put the thin tubes into liquid nitrogen for freezing preservation.

The small ruminant semen freezing diluent in the present invention can also be used in the two-step cryopreservation of semen of small ruminants such as sheep and goats, and steps thereof are to mix the sheep semen and the osmotic protective agent-free freezing diluent described in the present invention evenly in a ratio of 1:4-1:10; sub-package in 2 ml cryotube;, slowly lower the temperature to 5 ° C.; mix the above suspension and the lyophilized diluent containing the osmotic protective agent of the present invention evenly in a ratio of 1:1; further equilibrate the mixture for 1-3 hours at 5° C.; pipette 0.2 ml of mixture onto the dry ice for pre-freezing; finally freeze the pellets into liquid nitrogen for cryopreservation.

The osmotic protective agent-free freezing diluent described in the two-step cryopreservation method according to the present invention is prepared by respectively weighing 2.71 g of trishydroxymethyl aminomethane, 1.4 g of citric acid, and 1.0 g of monosaccharide, 0.1 million IU of penicillin, 0.1 million IU of streptomycin, 50-600 mMol of inositol, 0.1-50 μMol of resveratrol dissolve them in ultrapure water; stir evenly;; add 5-20 ml of fresh yolk inactivated at 56° C. for 30 min into solution before use; mix well; dilute to 100 ml; centrifuge the mixture at 15000 rpm for 1 hour at 4° C.; take the supernatant to filter with a 0.45 μm disposable filter for use.

For the freezing preservation of goat semen, in order to eliminate the adverse effect of phosphatase A and egg yolk interaction on sperm survival, it is preferred to mix semen and cleaning solution (mixed in a ratio of 1:10, centrifuged at 600 g for 15 min), take the supernatant, and wash the sperm precipitation again. Preparation method of cleaning liquid is to respectively weigh 2.71 g of trishydroxymethyl aminomethane, 1.4 g of citric acid, 1.0 g of monosaccharide, 0.1 million IU of penicillin, 0.1 million IU of streptomycin, 50-600 mMol of inositol compound, and 0.1-50 μMol of resveratrol, make them up to 100 ml with ultrapure water, and filter the solution with a 0.22 μm disposable filter for use.

The quality of the semen used for the cryopreservation of the present invention is: the vitality greater than 75%, and the sperm density higher than 1×10⁹/ml.

The beneficial effects of the present invention are as follows:
1. Appliance of resveratrol in the field of animal genetic material freezing: Resveratrol has been a research hotspot in recent years. Resveratrol is widely believed to have antioxidant, anti-mutation, cardiovascular, anti-inflammatory and antibacterial effects. It has been successfully applied in the fields of food, cosmetics and pharmaceuticals. The present invention aims at the main problems existing in the research of livestock semen freezing preservation at present. For the first time, the present invention combined the chemically synthesized ice crystal inhibitor and the natural plant extract, resveratrol, to use in freezing preservation of small ruminant livestock semen. Although mechanism by which the resveratrol reduces the damage ice crystals done to sperm cells is still unclear, a large number of experiments have shown that the introduction of resveratrol into semen freezing diluent can indeed improve quality indexes such as sperm survival rate, viability, acrosome integrity, plasma membrane integrity, the normal rate of mitochondrial membrane potential and artificial insemination non-return rate after semen freezing and thawing. That may be due to the similar molecular structure of resveratrol and the inositol compounds disclosed in the present invention, mechanical damage of extracellular formed ice crystals to structures such as plasma membrane and mitochondria can be reduced; in the meantime resveratrol is also an antioxidant that can effectively reduce oxidative damage of sperm at 0-5 ° C. low temperature equilibration; resveratrol can also prevent cell inflammation, which is also of positive significance to protect cells and reduce damage when semen cells are frozen. The present invention is the first to successfully apply resveratrol to the field of semen freezing of small ruminants
2. Improved quality of frozen semen. A large number of experiments have shown that the semen of the small ruminants freezing preserved by applying the semen freezing diluent of the present invention has the thawed sperm of vitality more than 50%, acrosome integrity about 65%, and plasma membrane integrity more than 50%, the normal rate of mitochondrial membrane potential above 70%, and the rate of non-return after artificial insemination over 70%.
3. Low cost and simple preparation. The inositol compound and resveratrol used according to the present invention are common chemical reagents, and are convenient to obtain, low in expenses, and chemically stable. The preparation method and the application method of the semen freezing diluent disclosed in the present invention are simple and easy to operate.

### DESCRIPTION OF SPECIFIC EMBODIMENTS

The technical solutions are further described by following specific embodiments, but the technical solutions are not restricted by the embodiments.

### Embodiment 1

Collect the Yunnan Semi-Fine Wool ram semen_with electric stimulation, and then test the semen quality. The sheep semen for freezing preservation must meet following requirements: viability greater than 75%, sperm density above 1×10⁹/ml, and semen volume of 1-2 ml.

Steps for preparing semen freezing diluent is to respectively weigh 2.71 g of trishydroxymethyl aminomethane, 1.4 g of citric acid, 1.0 g of glucose, 5% of glycerin, 0.1 million IU of penicillin, 0.1 million IU of streptomycin, 1,3-cyclohexanediol, 1 μMol of resveratrol; dissolve them in ultra-pure water; stir evenly; add 10 ml of fresh egg yolk inactivated at 56° C. for 30 min into the solution before use; mix well; dilute to 100 ml; centrifuge the mixture at 15000 rpm for 1 hour at 4° C.; and take the supernatant to filter with a 0.45 μm disposable filter for use.

Mix the qualified sheep semen and freezing dilutions in a ratio of 1:5; sub-package them in 0.25 ml plastic thin tubules; move it rapidly into the gaseous phase of liquid nitrogen for fumigation for 5 min; put the thin tube into liquid nitrogen for cryopreservation.

The livestock semen freezing preserved by the sadi method has the thawed sperm of survival rate 76.14±6.84%, the vitality 49.47±5.19%, the acrosome integrity 68.46±6.27%, the plasma membrane integrity 47.55±6.93%, and the normal rate of mitochondrial membrane potential 73.41±5.39%, and the rate of non-return after artificial insemination reaching over 70%.

### Embodiment 2

Collect Yunling Black goat semen with false vaginal and test the semen quality. The goat semen for freezing preservation must meet following requirements: viability greater than 75%, sperm density above 1×10⁹/ml, and semen volume being 1-2 ml.

Steps for preparing semen freezing diluent is to respectively weigh 2.71 g of trishydroxymethyl aminomethane, 1.4 g of citric acid, 1.0 g of fructcose, 5% of glycerin, 0.1 million IU of penicillin, 0.1 million IU of streptomycin, 50 mMol of 1,4-cyclohexanediol, and 10 μMol of resveratrol; dissolve them in ultra-pure water; stir evenly; and add 20 ml of fresh egg yolk inactivated at 56° C. for 30 min into the solution before use; mix well and dilute to 100 ml; centrifuge the mixture at 15000 rpm for 1 hour at 4° C.; and take the supernatant to filter with a 0.45 μm disposable filter for use.

The livestock semen freezing preserved by the said method has the thawed sperm of survival rate 72.68±5.42%, the vitality 48.58±3.27%, the acrosome integrity 68.19±4.26%, the plasma membrane integrity 45.79±8.16%, and the normal rate of mitochondrial membrane potential 71.55±7.41% and the rate of non-return after artificial insemination over 70%.

### Embodiment 3

Collect Dorset ram semen with electrical stimulation and test semen quality immediately. The ram semen for freezing preservation must meet following requirements: viability greater than 75%, sperm density above 1×10⁹/ml, and semen volume being 1-2 ml.

Steps for preparing the osmotic protective agent-free freezing diluents are to respectively weigh 2.71 g of trishydroxymethyl aminomethane, 1.4 g of citric acid, and 1.0 g of glucose, 0.1 million IU of penicillin, 0.1 million IU of streptomycin, 50 mMol of 1,3,5-cyclohexanetriol, and 8 μMol of resveratrol; dissolve them in ultrapure water; stir evenly; add 15 ml of fresh yolk inactivated at 56° C. for 30 minutes into the solution before use; mix well; dilute to 100 ml; centrifuge the mixture at 15000 rpm for 1 hour at 4° C.; and take the supernatant to filter with a 0.45 μm disposable filter for use.

Steps for preparing the freezing semen is to respective weigh 2.71 g of trishydroxymethyl aminomethane, 1.4 g of citric acid, and 1.0 g of fructose, 10% of glycerin, 0.1 million IU of penicillin, 0.1 million IU of streptomycin, 50 mMol of 1,3,5-cyclohexanetriol, and 8 μMol of resveratrol; dissolve them in ultrapure water; stir evenly; and add fresh yolk of 15 ml inactivated at 56° C. for 30 min into the solution before use; mix well; dilute to 100 ml; centrifuge the mixture at 15000 rpm for 1 hour at 4° C.; and take the supernatant to filter with a 0.45 μm disposable filter for use.

Mix the semen meeting the freezing requirements and the osmotic protective agent-free frozen diluent evenly at a ratio of 1:5, sub-package the above mixture into a 2 ml cryotube, slowly lower the temperature to 5° C., mix the above suspension and the semen freezing dilution of the livestock described in the present invention evenly in a ratio of 1:1, pipette 0.2 ml of the mixture onto the dry ice for pre-freezing, and finally freeze the pellets into liquid nitrogen for cryopreservation.

The sheep semen cryopreserved by above method has the thawed sperm of the survival rate being 74.58±7.35%, the vitality being 50.47±2.84%, the acrosome integrity being 71.32±5.43%, the plasma membrane integrity being 50.09±6.91%, the normal rate of mitochondrial membrane potential being 75.16±6.38%, and the rate of non-return after artificial insemination above 75%.

The above embodiments are merely illustration of the present invention and are not intended to limit the scope of the present invention.

The small ruminant semen freezing dilution provided by the present invention is described in details above. The principles and embodiments of the present invention have been described herein by way of specific embodiments, which are merely illustration of the embodiments of the present invention. It should be noted that those skilled in the art can make various modifications and changes to the present invention without departing from the spirit and scope of the present invention.

1. A small ruminant semen freezing diluent, wherein each 100 ml of it includes following components:
2.71 g of trishydroxymethyl aminomethane,
1.4 g of citric acid,
1.0 g of monosaccharide,
5-20 ml of fresh egg yolk,
0-10 ml of osmotic protective agent,
0.1 million IU of penicillin,
0.1 million IU of streptomycin,
50-600 mMol of inositol compounds,
0.1-50 μMol of resveratrol, and
the rest of which ultra-pure water, and wherein
the inositol compounds are one of 1,3-cyclohexanediol, 1,4-cyclohexanediol and 1,3,5-cyclohexanetriol.

2. (canceled)

3. The small ruminant semen freezing diluent according to claim 1, wherein the monosaccharide is glucose or fructose.

4. The small ruminant semen freezing diluent according to claim 1, wherein the osmotic protective agent is glycerin or ethylene glycol.

5. The small ruminant semen freezing diluent according to claim 1, wherein the fresh egg yolk has been inactivated at 56° C. for 30 minutes.
